(19) United States
(12) Patent Application Publication
(10) Pub. No.: US 2003/0136716 A1
(43) Pub. Date: Jul. 24, 2003

(54) Growing and conditioning system for bioaugmentation products used for the treatment of waste water and water quality improvement

(75) Inventors: Scott Moffitt, North Hatley (CA); Karl F. Ehrlich, North Hatley (CA); Bruce Arrington, Acushnet, MA (US)

Correspondence Address: ROBIC, 55 St Jacques, Montreal, H2Y 3X2, CA

(73) Assignee: AQUARESEARCH CANADA LTD./ AQUARECHERCHE CANADA LTEE

(21) Appl. No.: 10/346,287

(22) Filed: Jan. 17, 2003

(30) Foreign Application Priority Data
Jan. 18, 2002 (CA) 2,368,407

(51) Int. Cl. B01D 17/12

(52) U.S. Cl. 210/121; 210/139; 210/137; 210/151; 210/259; 210/513; 210/631; 210/614

(57) ABSTRACT

Disclosed is an improved, fully automated system for on-site growth and conditioning of microorganisms for use in water body restoration. The system includes a reservoir for the microorganisms and the nutrients, a bioreactor system, a water conditioning system, and an electrical control device.

It is improved in that the bioreactor system is partitioned or divided into a plurality of sub-compartments through which the growing culture flows.

Other improvements include:

providing an improved cabinet with improved components within the same to provide greater flow and storage capacity;

placing the reservoir out of the cabinet to give additional bioreactor system space and retention time within the cabinet;

adding influent water into the growth process to allow the cultures to adapt to changing pollutants;

using separate reservoirs for the bacteria and nutrients;

using an integrated water reservoir(s) to supply the bioreactor system, and to use one or more receiving container(s) to collect the active/conditioned cultures, and/or

making the system larger and free standing without its housing cabinet.

### BACKGROUND OF THE INVENTION

1. Field of the Invention

The present invention relates to an improved growing and conditioning system also called “improved Bacta-Pur® BACTIVATOR™” in the following description, which is devised to continuously preactivate or precondition bioaugmentation products.

This improved system is designed for the treatment of water from a variety of sources. More specifically, the improved system according to the invention is intended to be used for water body restoration, which encompasses an indefinite number of areas. Examples include waste water treatment plants (WWTP), sewers and drains, grease traps. The improved system according to the invention may also be used for industrial waste water treatment, aquaculture, agriculture, lake restoration, garden ponds, and for producing active cultures for retail sale for aquaria or garden ponds.

2. Brief Description of the Prior Art

A system of the above mentioned type is presently being sold by the Applicant, IET-AQUARESEARCH LTD, of North Hatley (Quebec). Such a system, which is called “Bacta-Pur® BACTIVATOR™”, is actually an automatic system, which continuously grows, conditions and delivers precise quantities of actively growing beneficial microorganisms selected for their ability to digest grease, clean pipes and/or prevent noxious odors. The existing Bacta-Pur® BACTIVATOR™ is designed and engineered to overcome inadequacies of other previous systems where dormant cultures poured or pumped from a bottle or pail are flown through and out of a grease trap, drain or sewer, before they even wake up. Such an addition of dormant cultures is described, for way of examples, in U.S. Pat. Nos. 5,578,211 and 5,578,841. Efficient activity of microbial cultures requires them to be in a specific and optimal physiological condition. All dormant or stabilized products are inactive. They have to be to half shelf-life. Temperature is a master factor affecting the activity of biological systems. The effect of temperature on the activity of microbes within a viable range, is usually defined by a factor called Q10. Q10 is the rate of change of activity with respect to temperature. Within the range of biological activity, Q10 is generally equal to about two. This implies that the activity doubles for every increase of 10° C. Thus, a rate at 15° C. will be twice that at 5° C., and a rate at 25° C. will be twice that at 15° C.

Efficient treatment of sewers also requires cultures which are not only active but also famished. Getting them consistently to this particular physiological condition, requires maintaining specific conditions. Temperature and chemical conditions within a sewer change temporally, seasonally and geographically. Thirty hours can be required at 30° C. to obtain the optimal physiological condition for grease digestion. Sixty hours will be required at 20° C. and 120 hours at 10° C. Sewer water can even be colder. Clearly, a major problem when adding dormant or stabilized cultures to a sewer is that such cultures may wake up out to sea or down stream, after having passed not only through the sewer but also through most of the waste water treatment facilities. Consistent work requires controlling the quality and condition of the microbial cultures before they are introduced into the sewer, drain or grease trap. This is the goal of the improved system according to the present invention.

It is also known that grease traps and drains receive intermittent doses of cleansers and disinfectants, which kill microorganisms—the good and the bad—. Therefore, continuous addition of cultures at the highest possible concentration and whose physiological condition have been optimized prior to their introduction into the targeted pieces of equipment to be cleaned, is the only way to maintain effective communities of beneficial microorganisms within the grease trap, drains or sewers.

The above mentioned U.S. Pat. Nos. 5,578,211 and 5,578,841 require specific monitoring of pollutional loading levels, such as nitrogen, to determine the dose rate of microbes. In practice, such is not easy as loadings in sewers are constantly fluctuating. U.S. Pat. Nos. 5,578,211 and 5,578,841 also suggest the use of ozone to control odors. Such is efficient. However, ozone is known to be highly corrosive and toxic.

The existing Bacta-Pur® BACTIVATOR™ presently sold by the Applicant has been engineered to meet cost-effectively all of the above challenges by automatically performing the following operations:

(1) adjusting the dose rate for a sewer treatment based on an average flow rate within the targeted sewer;

(2) bringing stabilized cultures of beneficial microorganisms out of dormancy;

(3) growing beneficial microorganisms to increase their numbers;

(4) activating and adjusting the physiological condition of the beneficial microorganisms to be in a rapid phase of growth to digest grease and sludge, prior to their addition to the traps, drains or waste water lines;

(5) continuously adding precise quantities of the active and famished cultures.

The existing Bacta-Pur® BACTIVATOR™ comprises five principal components, which are mounted in a rotomolded cabinet made of polyethylene (see FIG. 1 identified as “prior art”). These components include:

1. a single reservoir 1 for a mixture of beneficial microorganisms and nutrients;

2. a dual head dosing pump 2;

3. a bioreactor comprising two separate growing chambers 3, 3′;

4. an electrical system 5; and

5. an integral backflow prevention system 7.

The reservoir 1 may contain up to a 30-day supply of beneficial microorganisms and nutrients, thereby thus minimizing filling frequency. Such a 30-day supply is actually available only on machines which use no more than 300 mL/day of the mixture of beneficial microorganisms and nutrients. The maximum rate of supply of the existing Bacta-Pur® BACTIVATOR™ is actually 500 mL/day. At this maximum rate, the reservoir may only be active for 14 days.

The dual head dosing pump 2 of the existing system is used to deliver precise quantities of the mixture of beneficial microorganism and nutrient and water to the bioreactor.

As aforesaid, the bioreactor has two separate growing chambers 3,3′. Aeration is supplied to both chambers by an air pump 9. The first chamber 3 which receives the incoming mixture of beneficial microorganisms and nutrients and water, contains an immersion heater 11 to maintain the optimal growth temperature. This chamber 3 serves to bring the cultures out of dormancy and to begin their growth. The cultures then enters the second chamber 3′ before leaving the system and being fed into the drain or grease trap.

The electrical system 5 is used to operate the whole system and the integral back flow prevention system is used to eliminate any possibility of back flow into the water lines.

### OBJECTS OF THE INVENTION

As aforesaid, the present invention is concerned with several improvements to the basic structure of the existing Bacta-Pur® BACTIVATOR™ that has briefly been disclosed herein above.

More specifically, a main object of the present invention is to provide an improved, fully automated modular system for on-site growth and conditioning of microorganisms for use in water body restoration with a wide range of applications and great flow requirements, which system comprises:

at least one reservoir for stocking the microorganisms to be grown and nutrient required for such a growth and conditioning

a bioreactor system with a plurality of compartments partitioned by means of at least one internal division or dividing structure into at least two sub compartments including a first sub-compartment in which the microorganisms are brought out of dormancy in a culture containing the nutrients and water and then allowed to start growing, and a second and optionally further sub-compartments in which the culture of the first compartment flow and stay during appropriate retention times for cell growth;

a metering pump controlled by a timer to transfer a given amount of the microorganisms and nutrients from said at least one reservoir to the first sub-compartment of the bioreactor system;

a water supply unit to supply water to the first sub-compartment of the bioreactor system;

an air pump to supply air to all the sub-compartments of the bioreactor system;

an electrical control device connected to the pump(s), timer and heater for synchronizing their operation; and

outfall means to supply the culture containing the grown microorganisms from the second or optionally further sub-compartment of the bioreactor system, to the water body to be restored.

Other objects of the invention lie in other optional improvements made to the system, which include:

(1) providing an improved cabinet with improved components within the same to provide greater flow and storage capacity;

(2) the option of placing the reservoir out of the cabinet to give additional bioreactor system space and retention time within the cabinet;

(3) the option of adding influent water into the growth process to allow the cultures to adapt to changing pollutants;

(4) the option of using separate reservoirs for the bacteria and nutrients;

(5) the option of using an integrated water reservoir(s) to supply the bioreactor system, and to use one or more receiving container(s) to collect the active/conditioned cultures, and

(6) the option of making the system larger and free standing without its housing cabinet.

The above improvements distinguish the improved system according to the invention from the existing one as briefly disclosed hereinabove in the “Brief description of the prior art”, as it will now be explained in greater details within reference to the accompanying drawings.

### BRIEF DESCRIPTION OF THE DRAWINGS

FIG. 1 is a front elevational view of the existing Bacta-Pur® BACTIVATOR™ disclosed hereinabove in the “Brief description of the prior art”;

FIG. 2 is a schematic representation of the way the system shown in FIG. 1 can be installed in use;

FIG. 3 is a front elevational view of a preferred embodiment of the improved Bacta-Pur® BACTIVATOR™ according to the invention, shown without its door;

FIG. 4 is a front perspective view of the cabinet of the improved Bacta-Pur® BACTIVATOR™ shown in FIG. 3, having its door closed;

FIG. 5 is a front elevational view of another preferred embodiment of the improved Bacta-Pur® BACTIVATOR™ according to the invention, having its reservoir external to the main cabinet;

FIG. 6 is a front elevational view of a further preferred embodiment of the improved Bacta-Pur® BACTIVATOR™ according to the invention, comprising an influent supply line, pump and water disinfecting system including an ultraviolet sterilizer/filter unit to enhance biodegradation of changing and refractory pollutants especially when disinfected tap water is not used as a water source.;

FIG. 7 is a front elevational view of still another further preferred embodiment of improved Bacta-Pur® BACTIVATOR™ according to the invention with separate reservoirs for the bacteria and nutrients using collapsible bag or rigid reservoirs;

FIG. 8 is a front elevational view of still another preferred embodiment of the improved Bacta-Pur® BACTIVATOR™ according to the invention with an integrated water reservoir(s) to supply the bioreactor system and a receiving container(s) to collect the active/conditioned cultures;

FIG. 9 is a front elevational view of still another preferred embodiment of the improved Bacta-Pur® BACTIVATOR™ according to the invention, that is built without a cabinet, for larger applications;

FIG. 10 is a side perspective view of an improved Bacta-Pur® BACTIVATOR™ according to the invention, which is provided with an optional mechanical mix valve and warm water flow enhancer for use to combine hot and cold water to supply the system; and

FIG. 11 is a flow chart showing the interrelationship between the components of the improved Bacta-Pur® BACTIVATOR™ according to the invention as shown in FIG. 3.

### SUMMARY OF THE INVENTION

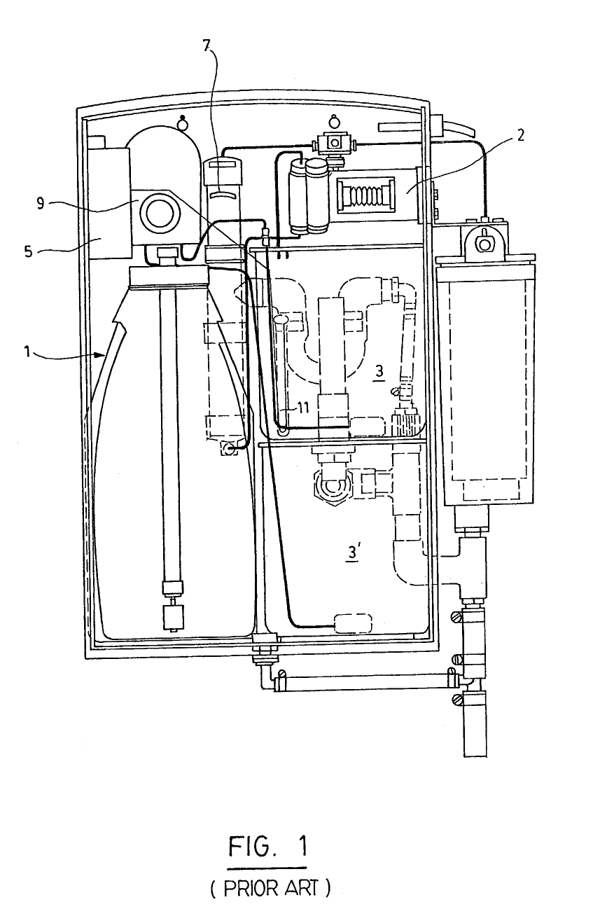

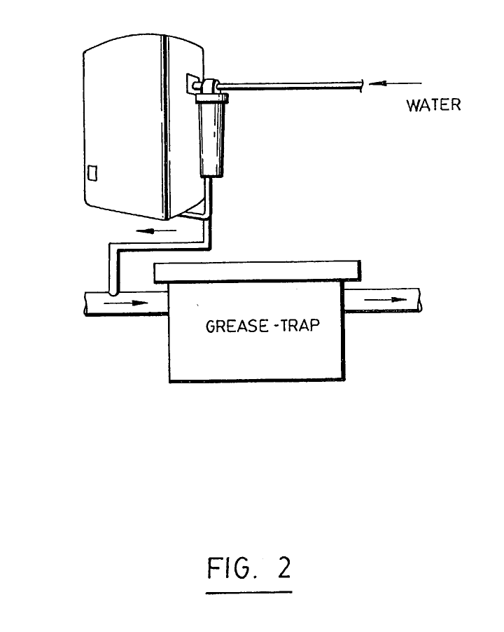

As aforesaid, the present invention is concerned with several improvements made to the basic structure of the existing Bacta-Pur® BACTIVATOR™ that was briefly disclosed hereinabove and is shown in FIGS. 1 and 2. These improvements are as follows:

1. Improved Cabinet and Components

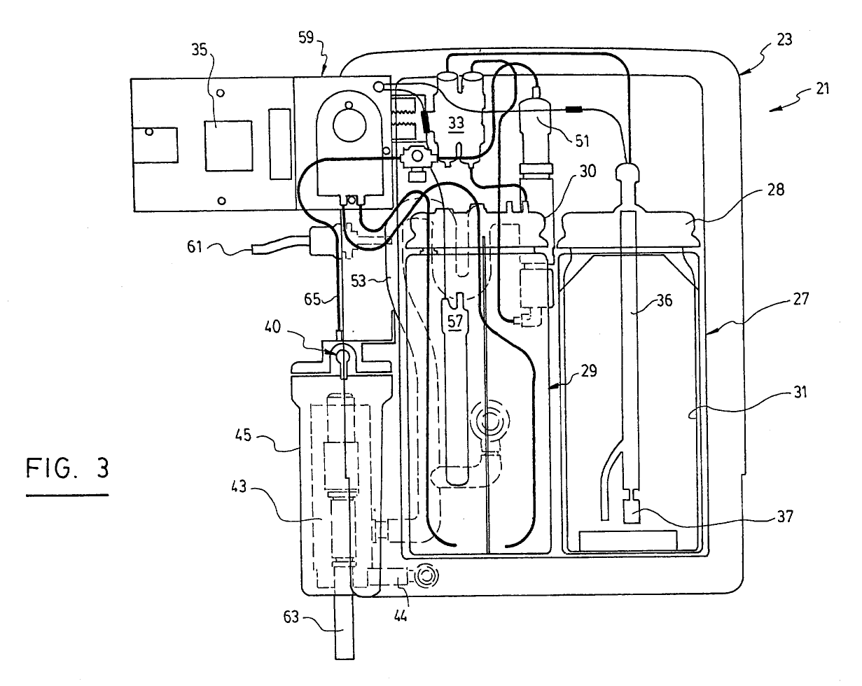

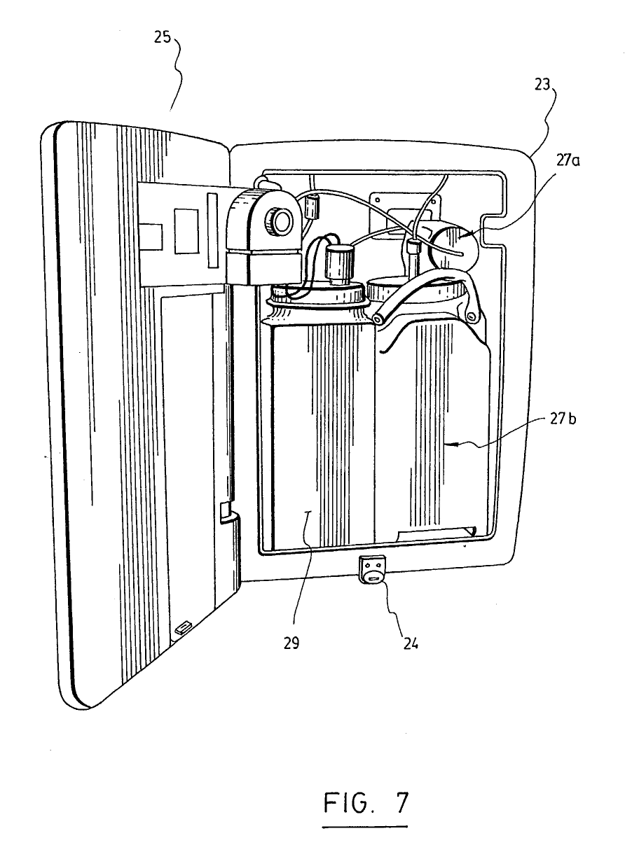

1. As shown in FIGS. 3 and 7, the arrangement of the reservoir and the bioreactor system within the cabinet of the improved system has been altered as compared to the existing one, to facilitate a more efficient servicing of the system. The positioning of the reservoir and the bioreactor system has been changed to a side-by-side arrangement. However, these two components could also be positioned in a front-to-back arrangement or a top-to-bottom arrangement (one sitting on top of the other).

2. The door latching/locking system has been updated to exclude the necessity of an external bulky hardware latching system as it was previously employed. As shown in FIG. 7, the door now opens a full 180° to facilitate servicing. Moreover, the locking system has been simplified and improved to provide a more secure closure.

3. The design of the system has been optimized so that the same “footprint” can now accommodate a larger volume of microorganisms. The effect of this improvement is to increase the ability of the units operational window (operating time) without requiring filling. Such is actually a space saving and compact design.

4. As also shown in FIGS. 3 and 7, the electrical components of the system have been incorporated into a modular box which provides easier access (servicing), safer design (self contained) and more efficient production, as this modular electrical box now becomes a manufacturing “subassembly”. The self-contained module is a hinged “electrical tray”, thereby facilitating access.

5. An installation system has been designed to allow for “one person installation”. This system includes a mounting plate that can be installed by one person. Then, the improved Bacta-Pur® BACTIVATOR™ can be simply lifted onto tabs which slide into openings provided on the back of the unit.

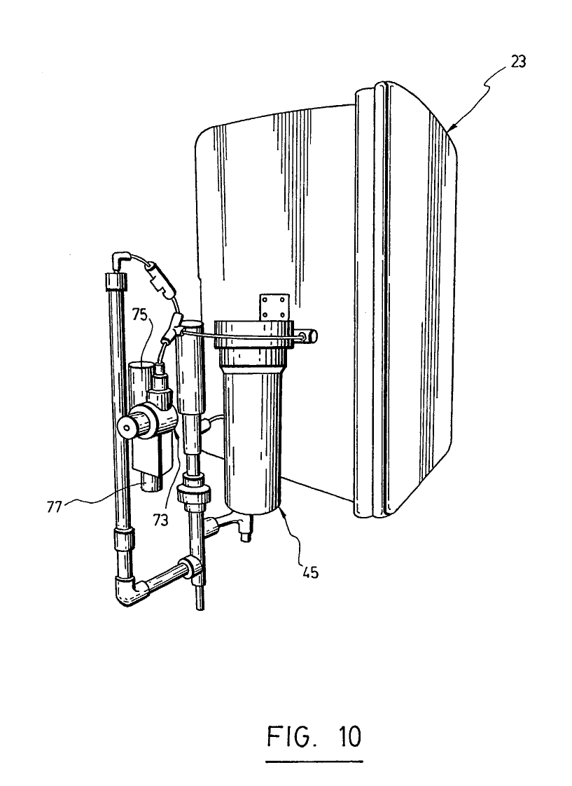

6. The bioreactor system has been redesigned for more efficient operation and such is one of the most important improvements made to the existing system. Instead of using one bioreactor comprising two physically separated compartments (not physically connected), use is now made of a single bioreactor system having a plurality of compartments partitioned by means of an internal division (see FIG. 3). Such a partitioning provides sub-compartments and better heat transfer between the sub-compartments. Such provides more homogeneous temperature between the two sub-compartments, while using only one heater. In areas with hard water, the existing system has had so far problems of salt build up on the heating element. This problem may now be controlled with the improved Bacta-Pur® BACTIVATOR™ according to the invention, thanks to the addition of a mechanical mix valve (see FIG. 10) which combines hot and cold water to deliver water at a constant target temperature (e.g. 30° C.). Thanks to the use of a mechanical mix valve, water entering the improved Bacta-Pur® BACTIVATOR™ arrives at a target temperature. Thus, heater use and salt build-up is minimized.

7. The existing Bacta-Pur® BACTIVATOR™ has been limited so far in its ability to digest grease in traps receiving high doses of highly toxic and non-degradable disinfectants, such as quaternary ammonia. The improved Bacta-Pur® BACTIVATOR™ according to the invention overcomes this problem with the optional addition of a warm water flow enhancer (see again FIG. 10). Such an enhancer combines hot and cold water through the above mentioned mechanical mix valve to provide a constant flow at a targeted temperature. The flow rate of the water is controlled by a series of emitters, which are plugged into a quick release connection and are simply changed.

In addition to the above, the following additional improvements have also been made:

8. The design of the cabinet has been updated to accommodate a total capacity of 30 liters of liquid products and a total weight of 40 kg.

9. The cabinet now has a drain assembly incorporated into its structural design.

10. The internal reservoir is provided with an ergonomic handle to facilitate servicing.

2. Option to Place the Reservoir Out of the Cabinet to Double the Bioreactor System Volume

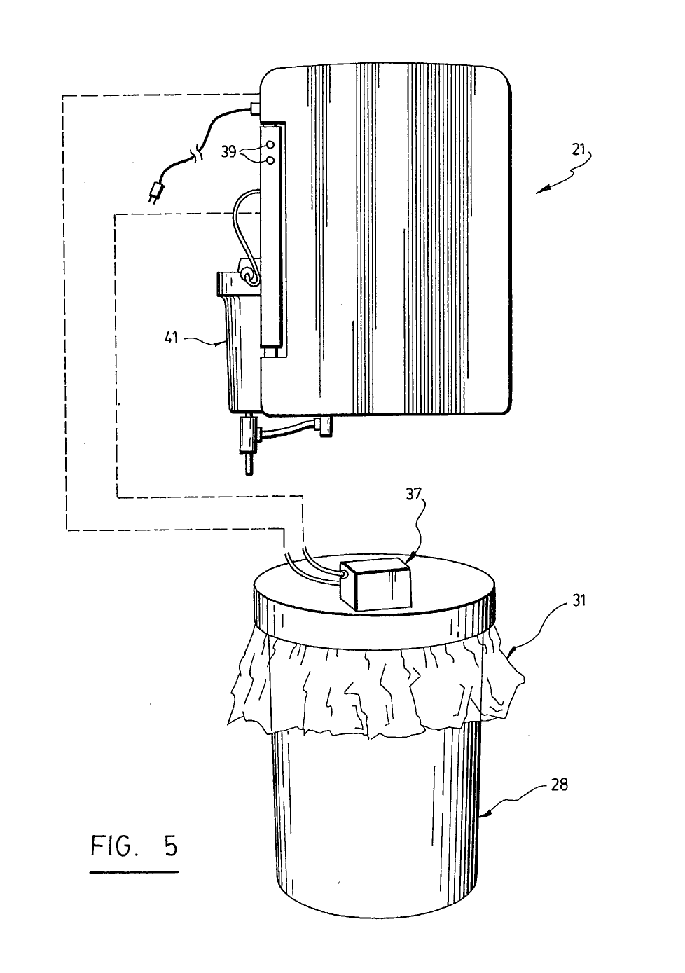

As an option (see FIG. 5), a larger external reservoir can be placed near the improved Bacta-Pur® BACTIVATOR™. The use of such an external reservoir eliminates the internal on and frees space for an additional bioreactor compartment. The new internal layout allows product use up to 1.5 L/day. Such corresponds to three times the capacity of the existing model—all in the same cabinet. The low level detector of the system may also be moved to the external reservoir.

3. Option of Providing Source of Influent Water to the Bioreactors System

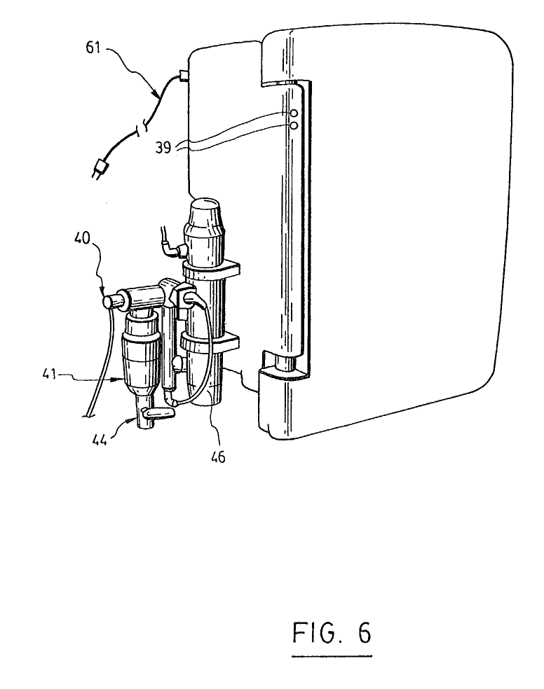

The ability of beneficial microorganisms to biodegrade refractory pollutants such as hydrocarbons requires that the microorganisms have time and appropriate conditions to develop internal enzymes to breakdown the targeted pollutants. An option of the improved Bacta-Pur® BACTIVATOR™ according to the invention is to include an additional pump or pump head to add small amounts of the ever changing influent water into the bioreactor system (see FIG. 6).

In use, the influent water may be filtered or screened and then disinfected prior to its introduction to the bioreactor system. Such allows targeted pollutants to enter the system, while minimizing the possibility of bacterial contamination.

4. Option of Providing Separate Bacteria and Nutrient Reservoirs

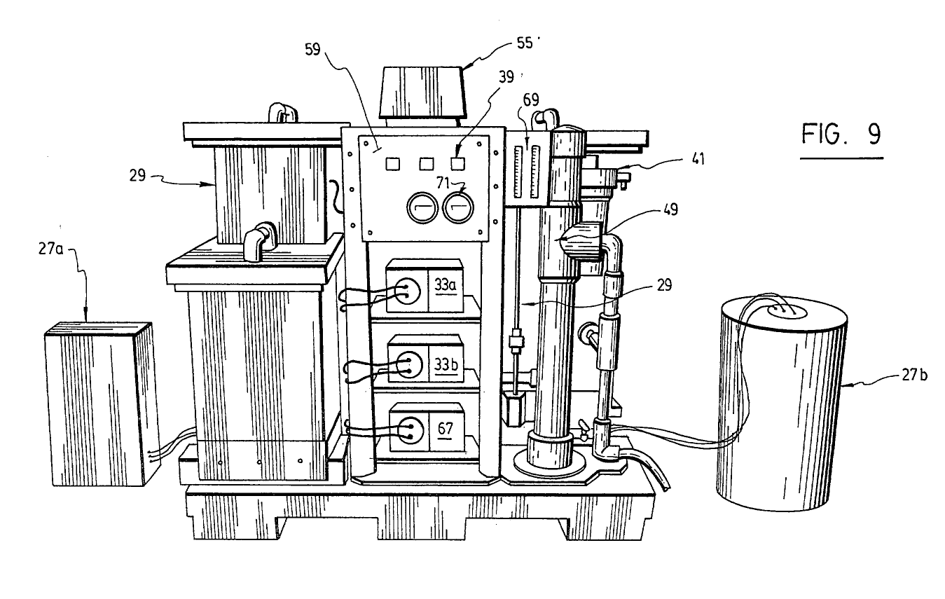

The improved Bacta-Pur® BACTIVATOR™ according to the invention may comprise two separate bacteria/nutrient reservoirs which may be internal to the cabinet (see FIG. 7) or external to the same (see FIG. 9): one for the cultures and the other for its nutrients. Such provides greater product stability over extended periods than when the cultures are mixed with their food.

5. Option of Using an Integrated Water Reservoir to Supply the Bioreactor and a Receiving Container to Collect the Active/Conditioned Cultures

Many bacterial products are sold for use in aquaria or garden ponds. These packaged products are dormant, which means that a few days can be required before benefits of their use can be optimized. This is particularly true for nitrifying bacteria. Active cultures offer many advantages. The existing Bacta-Pur® BACTIVATOR™ requires a flowing source of tap water and an overflow drain to proceed to such an activator. Both of these are not necessarily available in retail stores. The improved Bacta-Pur® BACTIVATOR™ according to the invention operates with a reservoir of tap water, like those use for drinking water dispensing machines. Flowing of water is not required with this option.

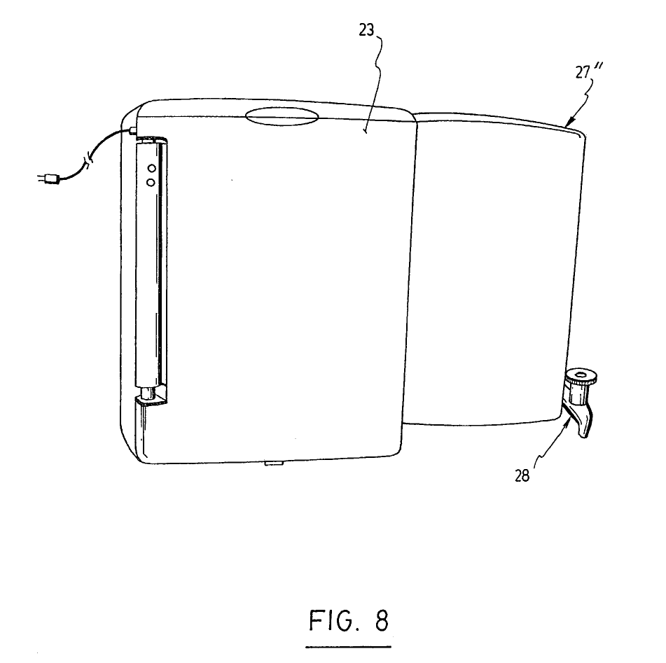

In addition to the above, the activated cultures may be collected in a vessel with a tap or faucet for dispensing (see FIG. 8). No cartridge and no water extra water are then needed. A pump sucks water from the water reservoir and the effluent of the bioreactor system goes into a receiving vessel with a tap.

With this configuration, the improved Bacta-Pur® BACTIVATOR™ according to the invention requires only a floor space and an electrical outlet.

Moreover, the improved Bacta-Pur® BACTIVATOR™ can be used to produce various active cultures on tap. These can include but are not limited to ammonia oxidizers, nitrite oxidizers, nitrate reducers, sludge digesters, and/or probiotics. . . The ability of retailers to sell various mixtures will allow the shop owner to develop his own house blends, such as in the coffee shops (e.g. Starbucks).

6. Option of Providing a Free Standing Bacta-Pur® BACTIVATOR™ without a Housing Cabinet

Many applications require volumes of cultures, which exceed the capacity of the cabinet of the existing Bacta-Pur® BACTIVATOR™. The application dose typically varies with the flow rate of the waste water. For instance, a waste water treatment plant with a flow rate of 100 million gallons/day could require approximately 80 gallons per day of product. This amount cannot easily be supplied by the smaller machines, with a maximal capacity of 1.5 L/day.

The improved Bacta-Pur® BACTIVATOR™ according to the invention differs from the existing one in that it may be made much larger. The larger model hereinafter called “Industrial Series Bacta-Pur® BACTIVATOR™” (see FIG. 9) comprises components typically built on a base of skids, which can be used for shipping as well as operation. Once again, positioning of the reservoirs for the beneficial microbes and the nutrients can vary depending on the site of the installation and the required dose rate.

The above mentioned Industrial Series Bacta-Pur® BACTIVATOR™ comprises of a water conditioning and control system which may include pumps for the beneficial microbes, the nutrients, water and influent, an air pump with control valves and flow indicators, multiple bioreactor system chambers or compartments with water heaters and temperature indicating valves.

A receiving vessel for the effluent and a secondary pump may also be included, when a gravity flow system is not adequate.

### DETAILED DESCRIPTION OF THE INVENTION

As aforesaid, the improved Bacta-Pur® BACTIVATOR™ according to the invention is an automatic system which continuously preactivates or preconditions bioaugmentation products.

More specifically, the improved Bacta-Pur® BACTIVATOR™ according to the invention automatically performs the following operations by maintaining optimal growing conditions in terms of temperature and oxygen concentration:

1. it brings stabilized cultures out of dormancy;

2. it grows the cultures to increase their numbers;

3. in a preactivating mode of operation, cultures are grown and then deprived of food so that they leave the machine famished and ready to digest grease or sludge immediately;

4. in a preconditioning mode of operation, cultures are grown and then induced to synthesize internal enzymes to biodegrade site-specific refractory products such as pollutants such as hydrocarbons, or to accelerate various steps of nitrification.

The improved Bacta-Pur® BACTIVATOR™ 21 according to the invention contains four main components, which are mounted:

either in a cabinet 23 (see FIGS. 3, 4, 6, 7 and 10)

or partially in a cabinet and partially freestanding (see FIGS. 5 and 8)

or completely freestanding or on a platform, such as a pallet (see FIG. 9).

The cabinet 23 is preferably made of rotomolded polyethylene. As is better illustrated in Fig.7, the cabinet has a hinged door 25 and an internal latching/locking mechanism 24 allowing the door to be padlocked. Such a mechanism advantageously excludes the necessity of an external latching system. It actually makes the door “easy to use” and it eliminates the necessity of using an external bulky hardware as was previously employed. As also shown in FIG. 7, the door now opens a full 180° to facilitate servicing. Moreover, the locking mechanism has been simplified and improved to provide a more secure closure.

The four main components of the improved system according to the invention as mentioned herein above include:

1. a reservoir 27 for the microorganisms and the nutrients, and in the embodiment shown in FIG. 5 a supplemental reservoir 28 for the water;

2. a multi-step bioreactor system 29;

3. a water conditioning system, and

4. an electrical control device.

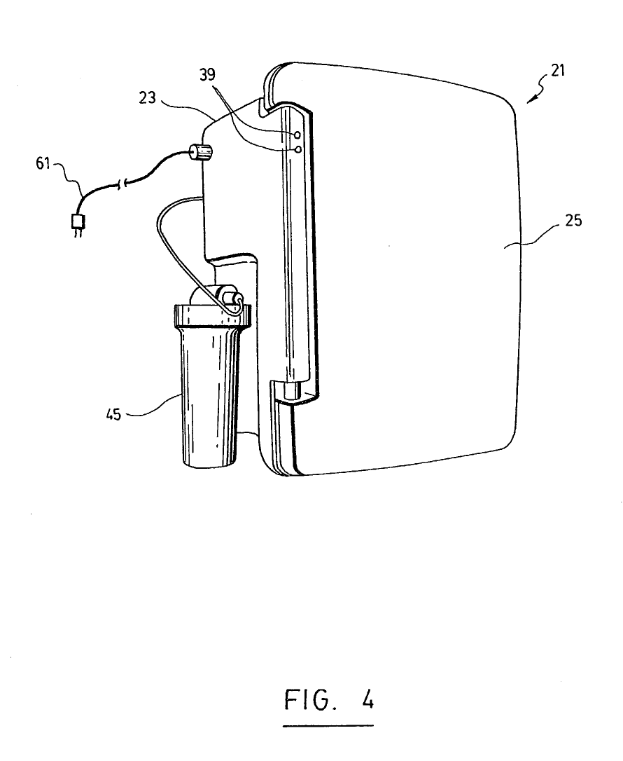

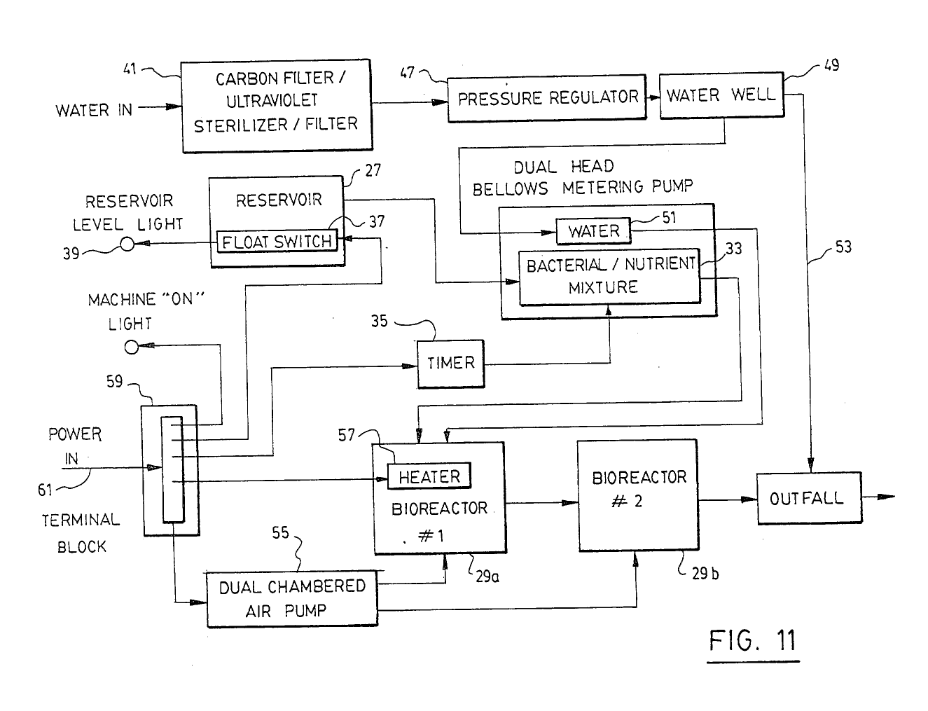

The reservoir(s) 27 and/or 28 preferably consist(s) of rigid container(s) closed by a cover, which are manufactured by rotomolding. However, they may also consist of a collapsible container such as a bag or any other type container (see FIGS. 5 and 9). The reservoir 27 contains a supply of microorganisms (also called “beneficial bacteria” or “bioaugmentation product”) and nutrients. Such bacteria and nutrients are preferably stored in a disposable plastic bag 31, which is changed at each filling. This avoids contamination in the reservoir from the mixing of old and new product. As shown in FIG. 11, one or more metering pump(s) 33, 55 and 67 which can be controlled by a timer 35, transfers a measured amount of the bacteria and nutrients to the bioreactor system 29 every day throughout the entire 24-hour period. A low level float switch 37 sends a signal to an indicator light 39 or alarm on the front face of the cabinet or to an electrical display panel, when the reservoir needs to be refilled (see FIGS. 4 to 6 and 9).

As mentioned hereinabove as option 4, the reservoir 27 may actually be “divided out” into a bacteria reservoir 27a and a nutrient reservoir 27b separated from each other (see FIGS. 7 and 9).

Water is introduced into the improved Bacta-Pur® BACTIVATOR™ 21 through a water supply unit including a quick release connector valve 40, an activated carbon filter 41 including a cartridge 43 mounted in a housing 45 provided with a drain 44 (as is illustrated in FIG. 3) and/or an ultraviolet sterilizer/filter unit 46 (see FIG. 6). Water preferably passes through a pressure regulator 47 to reduce and stabilize the incoming pressure to a preset PSI (see FIG. 11). Then, water enters a water well 49 (see FIG. 11) through a drip emitter and/or a flow control valve. This limits the daily water consumption to a measured amount. Another pump(s) 51 controlled by the timer 35 and/or by low adjustments, transfer(s) a measured amount of water from the well 49 to the bioreactor system 29 throughout the day. Excess water not needed for the process is allowed to overflow the water well through a “P” trap 53 to the outfall of the machine.

As mentioned hereinabove as parts 6 and 7 in option 1 and shown in FIG. 10, the improved system according to the invention may be provided with a mechanical mix valve 73 connected to a cold water source 75 and a warm water source 7 in order to combine warm and cold water to deliver water at a constant target temperature.

In the other preferred embodiment shown in FIG. 8 for use without a source of flowing water or a drain, disinfected water is stored in an internal or external reservoir from which the pump(s) 51 draws it throughout a 24-hour period. If desired, a second receiving reservoir 27″ with a faucet, tap spigot or tap 28 may be used to collect and then dispense the active and conditioned cultures (see FIG. 8).

The bioreactor system 29 of the improved Bacta-Pur® BACTIVATOR™ according to the invention, is preferably made also by rotomolding. In a particularly preferred embodiment of the invention, the bioreactor system 29 is in the form of one container closed by a cover 30 and partitioned to form at least two sub-compartments or growth chambers 29a, 29b, with an aeration available for each sub-compartment. Air is supplied to the sub-compartments by an air pump 55. The first sub-compartment 29a contains a temperature controlled immersion heater 57. The other sub-compartment may also comprise such an immersion heater. But such is not compulsory since both sub-compartments are in “contact”. The first sub-compartment 29a receives the incoming bacteria, nutrients and water, which are transferred by metering pump 33. This first sub-compartment 29a serves to bring the bacteria out of dormancy and to begin their growth. As more fluids enter the first sub-compartment 29a, the liquid cultures flow into the second compartment 29b and additional sub-compartments. The size of the sub-compartments, filling levels and flow rates are controlled to provide appropriate hydraulic retention times for the cell growth. Multiple sub-compartments allow the flow pattern to approximate plug-flow, which allows better process control than a single compartment, which would be a completely mixed batch reactor. In a completely mixed batch reactor, some of the newly added cultures would exit with the conditioned ones yielding a process with less uniformity and controls.

Of course, an electrical control device 59 is provided to operate the system. This device is made available for 120 v, 60 Hz or 220-240 v, 50 Hz. Wires for the timer 35 and main terminal block are contained in a hinged covered compartment placed at the top of the cabinet (see FIGS. 3 and 7) or above and in front of the bioreactor system in the freestanding model (see FIG. 9). Wires for the other components are connected to the main terminal block. A power cord 61 is provided on the unit.

As aforesaid, all of the electrical components of the control device 59 are incorporated into a modular electrical box, which allows for easier access (servicing) and increased safety (enclosed unit). Furthermore, the modular electrical box allows for a more efficient assembly as the unit now becomes a manufacturing “sub-assembly”. The self-contained modular electrical box is hinged in the cabinet so as to facilitate access both for the box and for components behind it.

As mentioned hereinafter as option 6, the improved Bacta-Pur® BACTIVATOR™ according to the invention may be made much larger than usual if need be. As shown in FIG. 9, such a larger system does not comprise a cabinet. However, it still comprises the four main components mentioned hereinabove, namely:

one or two reservoirs 27a, 27b for the microorganisms and nutrients;

a multi step bioreactor system 29;

a water conditioning system;

an electrical control device 59.

A frame may be provided to support the electrical control device 59 and several other elements of the system, such as the low lever indicator light 39, the metering pumps 33a, 33b for the bacterial and nutrient, a water influent pump 67 connected to a water source via a carbon filter 41 and the water well 49, the air pump 55, an air flow indicator 69 and a bioreactor system temperature indicator 71.

The advantages of all of these improvements have already been emphasized hereinabove.

In practice, one may activate the improved Bacta-Pur® BACTIVATOR™ disclosed hereinabove by carrying out the following steps.

Water & Drain Connection

1. Connect the outfall from the cabinet 23 to a drain or entrance to the area or structure to be treated. Use either a barb connector, with a flex hose, or a preferably a rigid pipe 63.

2. Attach the water filter assembly 43, 45 to the bolts protruding from the right side of the cabinet.

3. Insert water line 65 protruding from the side of the cabinet into the quick release connector valve 40 on the filter.

4. Connect a cold water line or water line from temperature mix valve to the inlet of the filter housing 45.

5. Turn on the water entering filter 43.

Bioreactor System Connection

1. Fill the compartments 29a, 29b of the bioreactor system with tap water until the water flows out of the drain.

Bacteria/Nutrient Reservoir Connection

1. Carefully fill the bag 31 in the reservoir 27 up to a line made in it or with a specified volume, which indicates the correct amount of bioaugmentation product. Then fill the bag with nutrient up to a next line also made in it or with a specified volume.

2. Place a rigid pipe 36 containing the level switch and the suction line of the bacteria/nutrient pump 23 into the reservoir 27. Tighten the cover 28 should be tightened or attached onto the top of the reservoir 27 and the pipe pushed down the pipe if instructed, until the float switch just touches the bottom of the reservoir (see FIG. 3).

Priming of the Pumps

1. Lift the cover 30 off of the bioreactor system 29 to have access to nipples acting as feed lines for the water and bacteria/nutrients. Connect a tubing of a syringe to one of the nipples and then fill the syringe. Such will fill the line and the pump head. Then, empty the syringe into the bioreactor system 29.

2. Repeat the process with a second nipple and again empty the syringe into+ the bioreactor system . Both pump heads should now be primed.

Energizing the Unit

1. Plug the electrical power cord 61 into a GFI protected receptacle of the correct voltage. A small amount of liquid should be seen being pumped briefly from the water line and from the reservoir of beneficial bacteria/nutrients. In practice, the pumps 33 and 51 are is programmed to work at a required frequency.

Then, the system is ready to operate.

Of course, numerous modifications could be made to the preferred embodiments that have been disclosed hereinabove without departing from the scope of the invention as defined in the appended claims.

1. An improved, fully automated system for on-site growth and conditioning of microorganisms for use in water body restoration, comprising:
at least one reservoir for stocking the microorganisms to be grown and nutrients required for such a growth and conditioning
a bioreactor system with a plurality of compartments, partitioned by means of at least one internal division or dividing structure into at least two sub-compartments including a first sub-compartment in which the microorganisms are brought out of dormancy in a culture containing the nutrients and water and then allowed to start growing, and a second and optionally further sub-compartments in which the culture of the first compartment flow and stay during appropriate retention times for cell growth;
a metering pump controlled by a timer to transfer a given amount of the microorganisms and nutrients from said at least one reservoir to the first sub-compartment of the bioreactor system;
a water supply unit to supply water to the first sub-compartment of the bioreactor system;
an air pump to supply air to all the sub-compartments of the bioreactor system;
an electrical control device connected to the pump(s), timer and heater for synchronizing their operation; and
outfall means to supply the culture containing the grown microorganisms from the second or optionally further sub-compartment of the bioreactor system, to the water body to be restored.

2. The improved system of claim 1, further comprising a low level float switch to send an alarm signal when said at least one reservoir needs to be refilled.

3. The improved system of claim 1, comprising two of said at least one reservoir, one of said at least two reservoirs being used for stocking the microorganisms, the other one of said reservoir being used for stocking the nutrients.

4. The improved system of claim 1, wherein the water supply unit comprising an activated carbon filter and/or an ultraviolet sterilizer/filter unit.

5. The improved system of claim 4, wherein the water supply unit also comprises a pressure regulator and a drip emitter and/or flow control valve.

6. The improved system of claim 5, wherein the water supply unit further comprises a water pump controlled by the timer to pump the requested water from a well or separate water reservoir and supply it to the first compartment of the bioreactor system.

7. The improved system of claim 5, wherein the water supply unit further comprises a mechanical mix valve connected to a cold water source and to a warm water source to combine cold and warm water and thus supply water at a constant desired temperature.

8. The improved system of claim 1, wherein the bioreactor system is provided with an immersion heater operatively connected to the electrical control device to maintain an optimal temperature for the microorganism growth.

9. The improved system of claim 1, wherein the electrical control device is incorporated into a modular box positioned to allow easy access and increased safety.

10. The improved system of claim 1, wherein said at least one reservoir, said bioreactor system, said metering pump and timer and said electrical control device are incorporated in a cabinet provided with a fully openable front door and a door latching/locking system.

11. The improved system of claim 10, wherein the cabinet is provided with a drain assembly.

12. The improved system of claim 1, further comprising an additional pump to add small amounts of changing influent water into the bioreactor system to allow the microorganisms to develop internal enzymes to break down pollutants contained within said changing influent water.

13. The improved system of claim 1, further comprising an additional reservoir for stocking water to be supplied to the bioreactor system.

14. The improved system of claim 1, wherein the outfall means is connected to another additional reservoir in which the culture containing the grown microorganism may be stored.

15. The improved system of claim 2, wherein:
the water supply unit comprising an activated carbon filter and/or ultraviolet sterilizer/filter unit;
the water supply unit also comprises a pressure regulator, a drip emitter and/or flow control valve and a water pump also controlled by the timer to pump the requested water from a well or water reservoir and supply it to the first compartment of the bioreactor; and
the bioreactor system is provided with an immersion heater operatively connected to the electrical control device to maintain an optimal temperature for the microorganism growth.

16. The improved system of claim 15, wherein:
the electrical control device is incorporated into a modular box positioned to allow easy access and increased safety;
said at least one reservoir, said bioreactor system, said metering pump and timer and said electrical control device are incorporated in a cabinet provided with a fully openable front door and a door latching/locking system.

17. The improved system of claim 16, comprising two of said at least one reservoir, one of said reservoirs being used for stocking the microorganisms, the other one of said reservoir being used for stocking the nutrients.

18. The improved system of claim 17, further comprising an additional reservoir for stocking water to be supplied to the bioreactor system and wherein the outfall means is connected to another additional reservoir in which the culture containing the grown microorganism may be stored.

19. The improved system of claim 2, wherein:
the water supply unit comprising an activated carbon filter and/or ultraviolet sterilizer/filter unit; and
the water supply unit further comprises a mechanical mix valve connected to a cold water source and to a warm water source to combine cold and warm water and thus supply water at a constant desired temperature.

20. The improved system of claim 19, wherein:
the electrical control device is incorporated into a modular box positioned to allow easy access and increased safety;
said at least one reservoir, said bioreactor, said metering pump and timer and said electrical control device are incorporated in a cabinet provided with a fully openable front door and a door latching/locking system.
